(19) United States
(12) Patent Application Publication
(10) Pub. No.: US 2003/0066445 A1
(43) Pub. Date: Apr. 10, 2003

(54) Device for inversion of sheets in a printing machine

(76) Inventor: Norbert Hans-Georg Neumann, Westensee/Brux (DE)

Correspondence Address: Lawrence P. Kessler, Patent Department, NexPress Solutions LLC, 1447 St. Paul Street, Rochester, NY, 14653-7103, US

(21) Appl. No.: 09/850,388

(22) Filed: Aug. 14, 2001

(30) Foreign Application Priority Data
May 18, 2000 (DE) 100 24 091.7

(51) Int. Cl. B41F 5/02

(52) U.S. Cl. 101/230

(57) ABSTRACT

Device for inversion of sheets in a printing machine. The inversion device includes two belts positioned over deflection pulleys which are crossed and rotated by 180° so that they can convey at least one sheet along an inversion path lying next to each other, and having support rolls which lie against them on both sides in the region of belts lying against each other and cause deflection of belts from the linear direction.

The invention concerns a device for inversion of sheets in a printing machine, especially during transport of sheets in a printing machine.

Printing machines are known in which sheets are fed back to printing groups for printing on both sides. Before the sheets are printed again, they must be inverted. It is known to use for this purpose two intersecting belts turned by 180°. Such an inverter rotates the sheet in the feed direction around its center axis so that the front and rear sides are exchanged, but the front edge is retained. Such inverters are only applicable for a narrow format range and paper thickness range. The speed and reliability are limited.

The task of the invention is to develop a device for inversion of sheets in a printing machine that operates reliably for a number of types of stock.

The task is solved with a device that has the features according to claim 1. Advantageous embodiments are apparent from the subclaims.

The invention is to be explained below with reference to the drawing, in which

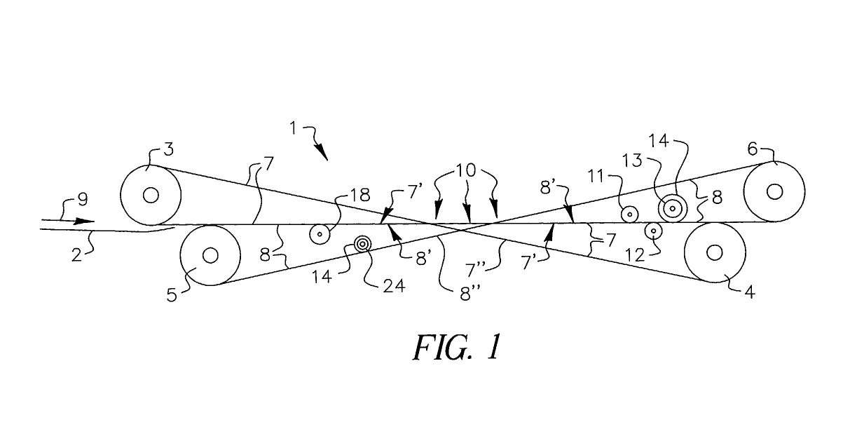

FIG. 1 shows a scheme of the printing machine in the longitudinal section,

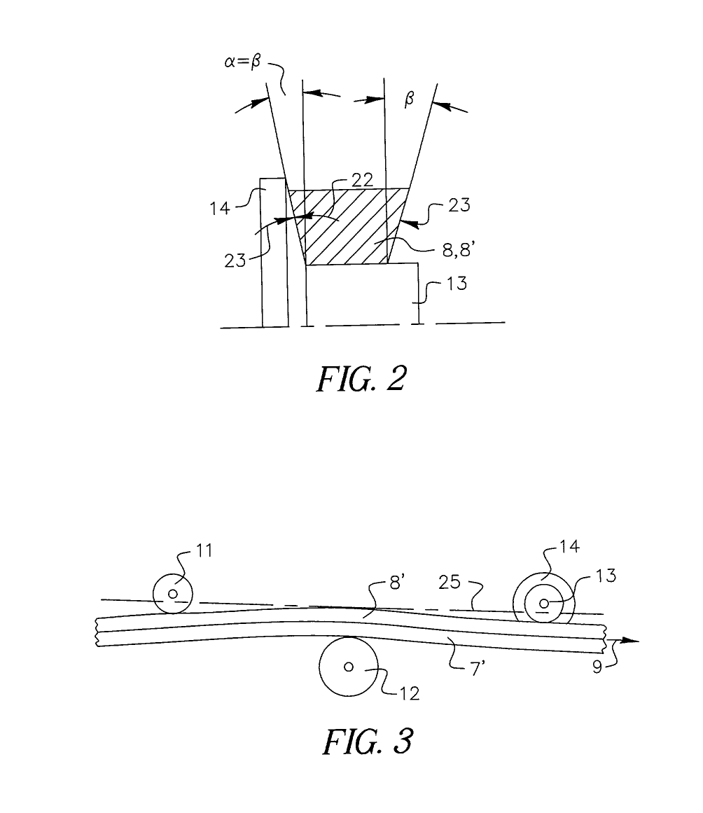

FIG. 2 shows a scheme of the inverter and

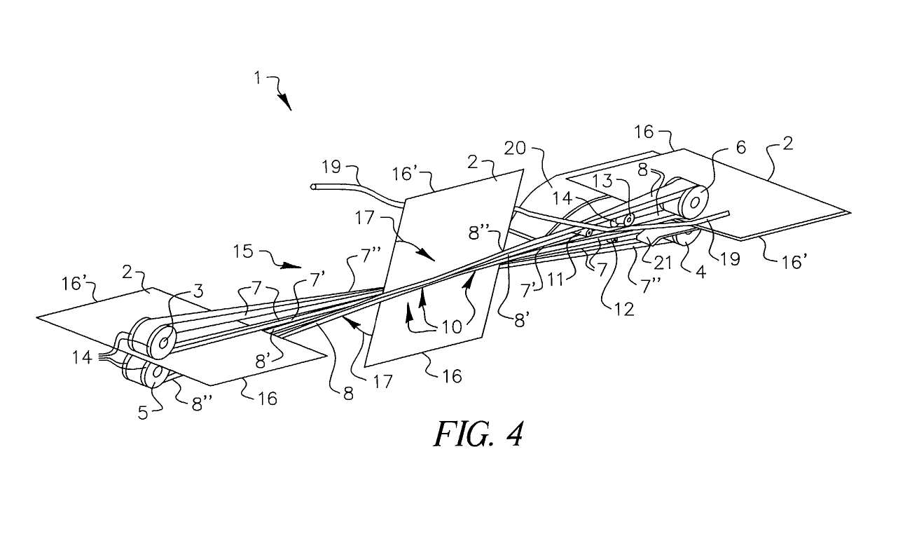

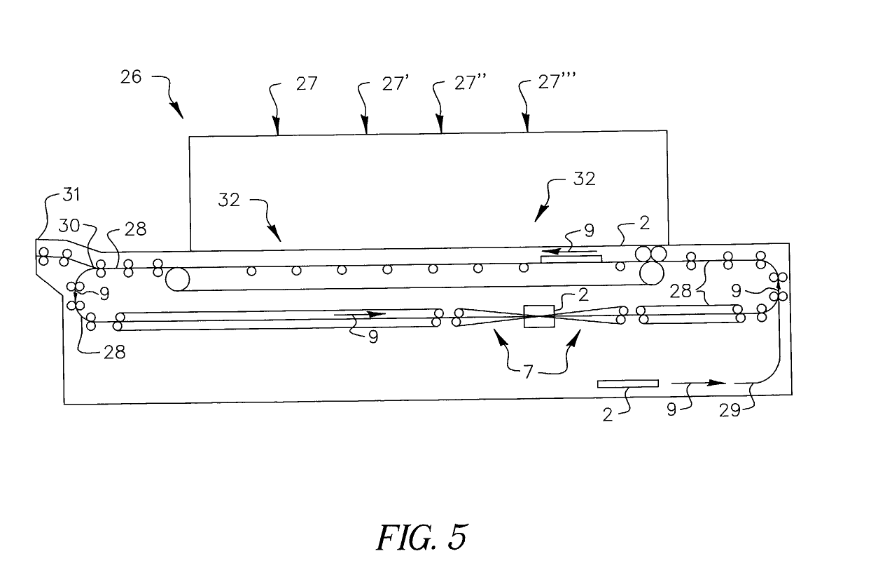

FIG. 3 shows a detailed view for the installation of support rolls.

The printing machine according to FIG. 1 contains a feed A with three supply containers 1, 2, 3 for sheets, which is arranged roughly in the bottom center. The sheets are separated with a suction belt system 4 and guided into the paper path of a delay unit 5. The sheets go from there to a conditioning unit B or a bypass 6. Via additional paper paths 7, 8, 9, the sheets go to a transport belt D and are conveyed past the printing groups 10. The conveyor belt D runs over a number of rolls. The rolls and additional elements form a conveyor belt support system that can be pivoted out. The ink on the printed sheet is cured in a fixation unit E. The sheets are delivered at a delivery F or fed back to the printing process via an inversion path G.

FIG. 2 shows an inverter in turning path G. Inverter H consists of two belts 11, 12 that are positioned over deflection pulleys 13, 14, 15, 16. The belts 11, 12 run crosswise and are rotated by 180°. The belts 11 and 12 lie next to each other with a strand side. A row of support sites in the form of support rolls 17, 18, 19 are placed on the belts 11, 12 above and below the common path of belts 11, 12. For deflection of the sheet edges, guide wires 20 and guide sheets 21 are arranged along the belts 11, 12 according to the sheet formats being processed. Kinking of the sheet edges is avoided by this.

FIG. 3 further shows how the support rolls 17, 18, 19 are arranged along the common path of belts 11, 12. The support rolls 17, 18, 19 press against the belt pair 11, 12 so that they deviate slightly from a linear guide and transport path 20. Because of this, a defined pressure force is achieved in the common support surface 21 of belts 11, 12. The support rolls 17, 18, 19 are essential, especially at the input and output of the inverter in order to achieve sufficient holding forces even with sheets that follow in close succession. The lateral guiding of belts 11, 12, guide elements 22 can be provided laterally on support rolls 17, 18, 19.

What is claimed is:

1. Device for inversion of sheets in a printing machine consisting of two belts (11, 12) positioned over deflection pulleys (13, 14, 15, 16), which are crossed and rotated by 180° so that they can convey at least one sheet along an inversion path lying next to each other, and consisting of support rolls (17, 18, 19), which lie against them on both sides in the region of belts (11, 12) lying against each other and cause deflection of belts (11, 12) from the linear direction.

2. Device according to claim 1, characterized by the fact that guide wires (20) and/or guide sheets (21, 22) are coordinated with belts (11, 12) along the inversion path.

3. Device according to claim 1, characterized by the fact that the support rolls (17, 18, 19) have a side guide (22) for the belts (11, 12).
